(19) United States
(12) Patent Application Publication
(10) Pub. No.: US 2026/0266617 A1
(43) Pub. Date: Sep. 10, 2026

(54) SYSTEM

(71) Applicant: SOFTBANK GROUP CORP., Tokyo (JP)

(72) Inventor: Kensuke HARADA, Tokyo (JP)

(73) Assignee: SOFTBANK GROUP CORP., Tokyo (JP)

(21) Appl. No.: 19/555,995

(22) Filed: Mar. 4, 2026

Related U.S. Application Data
(60) Provisional application No. 63/767,399, filed on Mar. 5, 2025.

(51) Int. Cl. G01C 21/34; G01C 21/36; G06N 3/0475; G06Q 20/40; G08G 1/01; G08G 1/04; G08G 1/052

(52) U.S. Cl. CPC G01C 21/3492; G01C 21/3602; G01C 21/3691; G06N 3/0475; G06Q 20/401; G08G 1/0112; G08G 1/0116; G08G 1/0129; G08G 1/0133; G08G 1/04; G08G 1/052

(57) ABSTRACT

A mobility support system combining AI technology, mobility services, and real-time data analysis is provided. Users input travel requests via terminals, and the AI analysis unit on the server generates optimal routes based on past travel history and real-time traffic data. The image analysis unit analyzes data from cameras or drones to monitor traffic conditions in real time. The mobility integration unit combines multiple transportation modes to provide a seamless travel experience. The payment unit settles fares for all transportation modes in a single transaction, reducing the user's financial burden. The disclosure aims to achieve efficient and comfortable travel while reducing stress associated with mobility.

### CROSS-REFERENCE TO RELATED APPLICATION

This application claims priority under 35 U.S.C. § 119 to U.S. Provisional Patent Application No. 63/767,399, filed on Mar. 5, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

A system and method for reducing the stress and inconvenience associated with mobility in modern urban life and to provide users with a more efficient and comfortable mobility experience is provided.

Specifically, it aims to solve problems such as traffic congestion, delays in public transportation, the complexity of transfers when using multiple modes of transportation, wasted time during travel, and the management of costs associated with mobility.

First, traffic congestion and public transportation delays are frequent problems in urban mobility, often causing users to arrive late at their destinations. AI technology and real-time traffic data is utilized to provide users with optimal travel routes, enabling them to avoid these issues.

Next, the complexity of transfers when using multiple modes of transportation places a significant burden on users. Mobility services, enabling seamless use on a single platform, is used thereby greatly reducing the hassle of transfers.

Furthermore, to minimize wasted time during travel, it learns users' travel patterns and proposes personalized travel routes, enabling efficient travel. It also enhances the user's travel experience by providing valuable information and services during the journey.

Finally, managing travel expenses is a critical factor for users. Simplified expense management and reduced user's financial burden is realized by providing a system that enables consolidated payment for multiple transportation modes.

Following means are provided to solve the challenges related to user mobility.

First, it includes an input unit that receives travel requests from users. This input unit provides an interface for users to input information such as departure location, destination, desired arrival time, budget, and preferred mode of transportation. This enables the initiation of travel plans tailored to the user's needs.

Next, it includes an AI analysis unit that analyzes the user's past travel history, current traffic conditions, weather information, and event information based on the travel request received from the input unit.

This AI analysis unit uses machine learning algorithms to learn the user's travel patterns and generate personalized travel routes. Furthermore, it utilizes real-time information from traffic data providers and sensors to understand current traffic conditions and propose the optimal travel route.

Furthermore, it includes an image analysis unit that analyzes image data from cameras and drones installed throughout the city. This image analysis unit gathers real-time information on road congestion levels and accident information. It collaborates with the AI analysis unit to provide users with the latest traffic information. This enables dynamic adjustment of the optimal travel route, enhancing the user's travel experience.

It also includes a mobility integration unit that integrates multiple transportation modes to provide seamless travel. This mobility integration unit enables the use of services such as public transportation, sharing services, taxis, and rental cars on a single platform, reducing the hassle of transfers.

Finally, it includes a payment unit that handles consolidated billing for services provided through the mobility integration unit. This payment unit aggregates fees for each service based on the user's ID information, enabling convenient payment. This allows users to centrally manage their travel expenses, reducing their financial burden.

Through the above means, the present invention enables the provision of an efficient and comfortable mobility experience for users, reducing the stress associated with travel.

### BRIEF DESCRIPTION OF THE DRAWING

FIG. 1 is a conceptual diagram showing an example configuration of the data processing system according to the first embodiment.

FIG. 2 is a conceptual diagram showing an example of the main functions of the data processing device and smart device according to the first embodiment.

FIG. 3 is a conceptual diagram showing an example configuration of a data processing system according to a second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 A conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, the signed processor (hereinafter referred to simply as the "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiment, the coded communication interface is an interface including a communication processor and an antenna, etc. The communication interface governs communication between multiple computers. Examples of communication standards applicable to the communication interface include wireless communication standards such as 5G (5th Generation Mobile Communication System), Wi-Fi (registered trademark), or Bluetooth (registered trademark).

In the following embodiments, "A and/or B" is synonymous with "at least one of A and B." That is, "A and/or B" may mean A alone, B alone, or a combination of A and B. Furthermore, in this specification, when three or more items are connected using "and/or," the same concept applies as for "A and/or B".

### First Embodiment

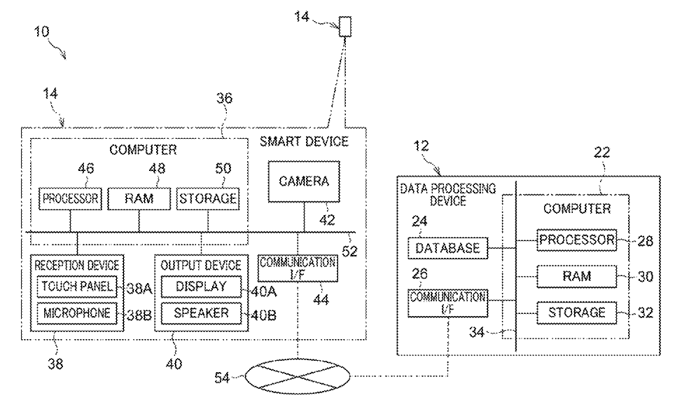

FIG. 1 shows an example configuration of the data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, among other components, and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

The output device 40 includes a display 40A and a speaker 40B, among others. It presents data to the user 20 by outputting it in a form perceptible to the user 20 (e.g., voice and/or text). The display 40A displays visual information such as text and images according to instructions from the processor 46. The speaker 40B outputs voice according to instructions from the processor 46. The camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

The communication interface 44 is connected to the network 54. The communication interfaces 44 and 26 manage the exchange of various information between processor 46 and processor 28 via network 54.

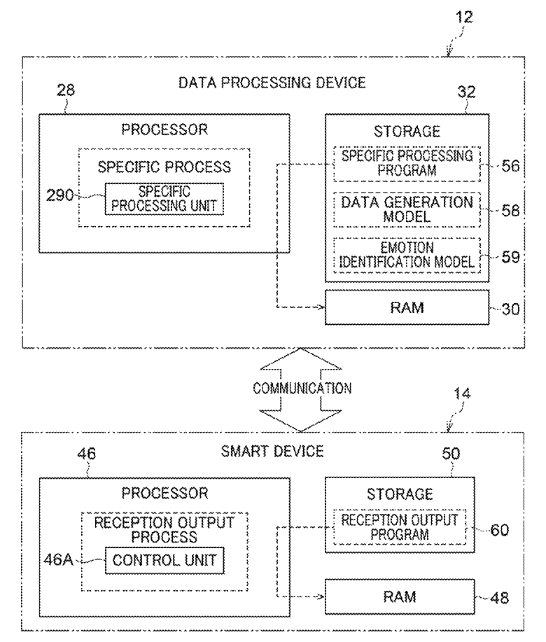

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The storage 50 stores the reception output program 60. The reception output program 60 is used in conjunction with the specific processing program 56 by the data processing system 10. The processor 46 reads the reception output program 60 from the storage 50 and executes the read reception output program 60 on the RAM 48. The specific processing involves executing the power program 60 on the RAM 48. The specific processing is realized by the processor 46 operating as a control unit 46A according to the specific processing program 60 executed on RAM 48. The smart device 14 operates as a control unit 46A in accordance with the specific processing program 60 executed on RAM 48. The smart device 14 also includes a data generation model 58 and an emotion identification model 59. The reception output processing is realized by the processor 46 acting as a control unit 46A according to the specific processing program 60 executed by the processor 46 on RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

The embodiments for implementing the present invention will now be described in further detail. This system is realized on both the server and the terminal, with each component performing its respective role to provide the user with an optimal mobile experience.

First, an input unit that receives the user's travel request is implemented on the terminal. The terminal comprises various devices such as smartphones, tablets, notebook computers, and even in-vehicle devices. Users can input detailed travel information through dedicated applications on these terminals, including departure location, destination, desired arrival time, budget, preferred mode of transportation, and even specifications for particular routes or waypoints. This input unit provides diverse interfaces such as voice recognition, touch operation, and gesture control, designed for intuitive user operation. For example, users can specify destinations via voice commands or set desired routes by drawing paths on a map using their fingers.

Next, the AI analysis unit is implemented on a server. The server is located in a cloud computing environment with advanced computational power, responsible for big data processing and executing machine learning algorithms. The AI analysis unit receives travel requests sent from the terminal and comprehensively analyzes the user's past travel history, current traffic conditions, weather information, and event information. For example, it learns routes the user frequently used in the past and preferred modes of transportation, generating personalized travel routes based on this. It also acquires real-time information from traffic data providers, dynamically adjusting routes to account for traffic congestion and public transportation delays. Specifically, the AI can predict road congestion patterns during specific time periods based on historical data and suggest optimal departure times to the user.

The image analysis unit is also implemented on the server. This unit receives and analyzes image data from surveillance cameras, traffic cameras, and even drones installed throughout the city. Congestion levels, accident information, pedestrian flow, and public transportation crowding are monitored in real time. For example, traffic volume at specific intersections is monitored, and if congestion occurs, the AI analysis unit collaborates to immediately propose alternative routes. It can also use video data to evaluate the crowding levels of buses and trains, suggesting comfortable transportation options to users. Furthermore, aerial photography using drones enables the monitoring of traffic conditions over a wide area, allowing for rapid response to traffic fluctuations caused by sudden accidents or events.

The Mobility Integration Unit is implemented on both the server and the terminal. The server handles backend processing to integrate multiple transportation modes, while the terminal provides the interface offering integrated services to users. For example, if a user wishes to combine train and bus travel, the server integrates the respective operation information and calculates the optimal transfer points and times. The terminal presents this information to the user, reducing the hassle of transfers. Additionally, sharing services and taxi reservations can be handled on a single platform. Specifically, the system automatically reserves the nearest shared bicycle or taxi just before the user arrives at their destination, enabling smooth travel.

Finally, the payment component is implemented on the server. It integrates fares from multiple transportation modes based on the user's ID information and provides a consolidated payment function. For example, if a user takes a train, bus, and taxi, the respective fares are combined and can be paid in one transaction via credit card or digital wallet. This payment system employs encryption technology to protect data, ensuring secure and swift transactions. Additionally, users can utilize a dashboard to manage their travel history and expenses, enabling them to view detailed reports on past trips.

As described above, the present invention realizes a system that provides users with an efficient and comfortable travel experience by linking servers and terminals. This reduces the stress associated with travel and enables the provision of new value to users.

### System Configuration

The system according to this embodiment comprises an input unit, an AI analysis unit, an image analysis unit, a mobility integration unit, and a payment unit.

The input unit provides an interface for users to input information related to their travel. Specifically, it is implemented on terminals such as smartphones, tablets, laptops, or in-vehicle devices, allowing users to input their departure location, destination, desired arrival time, budget, and preferred mode of transportation. For example, users can verbally specify their destination using voice recognition functionality. Users can also intuitively set routes by tapping destinations on a map. Furthermore, it includes a feature that suggests recommended routes to users based on their past travel history. Users can also set desired routes by drawing paths on the map using finger gestures.

The AI analysis unit, implemented on the server, receives travel requests from users and comprehensively analyzes past travel history, current traffic conditions, weather information, and event information. Specifically, it uses machine learning algorithms to learn the user's travel patterns and generate personalized travel routes. For example, it can prioritize suggesting routes the user has frequently used in the past or preferred modes of transportation. It also acquires real-time information from traffic data providers and dynamically adjusts routes to account for traffic congestion and public transportation delays. Furthermore, it can predict road congestion patterns during specific time periods and suggest optimal departure times to users. Prompt examples for the Generative AI include prompts such as "Generate the optimal travel route based on the user's past travel history" or "Propose a route that avoids congestion by considering real-time traffic data."

The image analysis unit is implemented on a server, receiving and analyzing image data from surveillance cameras, traffic cameras, and drones installed throughout the city. Specifically, it monitors road congestion levels, accident information, pedestrian flow, and public transportation crowding in real time. For example, it monitors traffic volume at specific intersections and, if congestion occurs, collaborates with the AI analysis unit to immediately propose alternative routes. It can also evaluate bus and train crowding levels using video data and suggest comfortable transportation options to users. Furthermore, aerial footage captured by drones enables monitoring of wide-area traffic conditions, allowing rapid response to traffic fluctuations caused by sudden accidents or events. Specific examples of prompts fed to the generative AI include: "Analyze video data and evaluate road congestion levels" and "Use drone footage to grasp wide-area traffic conditions."

The Mobility Integration Unit is implemented on both servers and terminals. It performs backend processing to integrate multiple transportation modes and provides users with an interface offering integrated services. Specifically, for users seeking combined train and bus travel, it integrates the respective operation information and calculates optimal transfer points and times. For example, it automatically reserves the nearest shared bicycle or taxi just before the user arrives at their destination, ensuring a smooth transition. Additionally, sharing services and taxi reservations can be made on a single platform. Specific examples of prompt sentences to feed into the generative AI include: "Integrate multiple transportation modes and propose the optimal travel plan" or "Achieve seamless transfers according to the user's travel needs."

The payment component is implemented on the server and provides a function to consolidate fares from multiple transportation modes based on the user's ID information, enabling a single payment. Specifically, if a user takes a train, bus, and taxi, the respective fares are combined and can be paid at once via credit card or digital wallet. For example, encryption technology is used to protect data, ensuring safe and swift transactions. Users can also utilize a dashboard to manage their travel history and expenses, enabling them to view detailed reports on past trips. Specific examples of prompts to feed into the generative AI include: "Integrate fares from multiple transportation modes and enable consolidated payment" and "Provide a dashboard for managing user expenses."

As described above, the system according to this embodiment provides users with an efficient and comfortable travel experience through the coordinated operation of its various components. This reduces travel-related stress and enables the delivery of new value to users.

### Implementation Steps

### Step 1: User Information Input

The user accesses a dedicated application using a device such as a smartphone or tablet. Here, the user inputs information such as the departure location, destination, desired arrival time, budget, and preferred mode of transportation. Input can also utilize voice recognition functionality, allowing the user to verbally specify the destination. Users can also intuitively set a route by tapping the destination on the map. Furthermore, the application features a function that suggests recommended routes to the user based on past travel history. Users can also set their desired route by drawing it on the map using a finger via gesture control.

### Step 2: AI Route Analysis

The input information is sent to the AI analysis unit on the server. The AI analysis unit comprehensively analyzes the user's past travel history, current traffic conditions, weather information, and event information. Using machine learning algorithms, it learns the user's travel patterns and generates personalized travel routes. For example, it can prioritize suggesting routes the user has frequently used in the past or preferred modes of transportation. Specific examples of prompt sentences fed to the generative AI include: "Generate the optimal travel route based on the user's past travel history" or "Suggest a route avoiding congestion by considering real-time traffic data."

### Step 3: Video Data Analysis

The video analysis unit on the server receives and analyzes video data from surveillance cameras, traffic cameras, and drones installed throughout the city. It gathers real-time information on road congestion levels, accident reports, pedestrian flow, and public transportation crowding. For example, it monitors traffic volume at specific intersections and, when congestion occurs, collaborates with the AI analysis unit to instantly propose alternative routes. Furthermore, it can evaluate bus and train crowding levels using video data and suggest comfortable transportation options to users. Specific examples of prompts fed to the generative AI include: "Analyze the video data and evaluate road congestion levels" and "Use drone footage to assess traffic conditions over a wide area."

### Step 4: Mobility Service Integration

The Mobility Integration Unit is implemented on both the server and the terminal, performing backend processing to integrate multiple transportation modes. It possesses an interface to provide integrated services to users. For users desiring travel combining trains and buses, it integrates the respective operation information and calculates the optimal transfer points and times. For example, it automatically reserves the nearest shared bicycle or taxi just before the user arrives at their destination, enabling smooth travel. Specific examples of prompts to feed into the generative AI include: "Integrate multiple transportation modes and propose the optimal travel plan" or "Achieve seamless transfers based on the user's travel needs."

### Step 5: Payment Processing

The payment component is implemented on the server. Based on the user's ID information, it integrates the fares for multiple transportation modes and provides a function for consolidated payment. When a user utilizes trains, buses, and taxis, the respective fares are combined, enabling payment in a single transaction via credit card or digital wallet. To ensure secure and swift transactions, data is protected using encryption technology. Additionally, users can access a dashboard for managing travel history and expenses, allowing them to view detailed reports on past trips. Specific examples of prompts to feed into the generative AI include: "Integrate fares from multiple transportation modes and enable consolidated payment" and "Provide a dashboard for managing user expenditures."

### Specific Use Cases

For example, consider a user seeking efficient transportation to attend a business meeting in an urban area. This user accesses a dedicated application via their smartphone, setting their departure location as their home, destination as a meeting room in the business district, desired arrival time as 10:00 AM, and budget within a specified amount. Furthermore, the user inputs preferences prioritizing comfort and, if possible, avoiding congestion.

This information is transmitted from the device to the AI analysis unit on the server. The AI analysis unit past travel history, analyzing previously used routes and preferred modes of transportation. It also acquires real-time traffic data, taking into account current road congestion and public transportation schedules. Based on this data, the AI generates the optimal travel route. This route might involve, for example, walking to the nearest station, taking a less crowded train, and then using a shared bicycle from a station near the destination.

The image analysis unit analyzes video data from cameras and drones installed throughout the city to grasp road congestion levels and accident information in real time. This enables the AI analysis unit to respond to sudden traffic changes and provide users with the latest traffic information. For example, if a train delay occurs, it can immediately propose an alternative route.

The Mobility Integration Unit integrates multiple transportation modes, such as trains, shared bicycles, and taxis, to provide users with a seamless travel experience. Users can reserve all these services at once via the application, reducing the hassle of transfers. For example, it can automatically reserve the nearest taxi just before arriving at the destination, ensuring smooth travel.

The payment unit provides a function to consolidate fares for each transportation mode based on the user's ID information and settle them in a single transaction. Users can pay all travel expenses at once via credit card or digital wallet. This reduces the financial burden of travel and facilitates expense management.

Specific examples of prompts for the generative AI include: "Generate the optimal route based on the user's travel needs," "Propose a travel plan that avoids congestion by considering real-time traffic data," "Analyze video data to evaluate road congestion levels," "Integrate multiple transportation modes to provide a seamless travel experience," and "Provide a dashboard for managing user expenses."

Thus, the present invention enables the provision of an efficient and comfortable travel experience to users, reducing the stress associated with travel.

### Application Example 1

The flow of specific processing in Application Example 1 is described below. The components of the system described below are implemented by the data processing device 12 and the smart device 14. The data processing device 12 is referred to as the "server," and the smart device 14 is referred to as the "terminal."

### Implementation Examples for the Present Invention

The embodiment for implementing the present invention is described in further detail below. This system includes a sensor unit, an AI analysis unit, a mobility integration unit, and a payment unit to highly optimize city-wide traffic management.

First, the sensor unit collects real-time traffic data using sensors, surveillance cameras, and drones installed at major intersections and key traffic points within the city. Specifically, surveillance cameras monitor the flow of vehicles on roads and can measure traffic volume and speed. This enables accurate assessment of how congested specific roads are. Drones monitor traffic conditions over a wide area from the air, instantly detecting fluctuations caused by sudden accidents or events. For example, drones can monitor areas hosting specific events from above, providing real-time insights into participant flows and vehicle congestion. Additionally, sensors may be installed at stations or bus stops to track public transportation operations and pedestrian flows. This enables the immediate acquisition and provision of bus and train delay information to users.

Next, the AI analysis unit predicts traffic flow and generates optimal travel routes based on data collected by the sensor unit. The AI analysis unit uses machine learning algorithms to compare historical traffic data with current conditions and predict traffic flow. For example, it learns road congestion patterns during specific time periods and generates optimal travel routes based on this learning. Furthermore, the AI considers each citizen's travel history and preferences to provide personalized travel plans. This enables users to reach their destinations in the shortest possible time. Additionally, the AI monitors traffic conditions in real time and can respond to sudden traffic changes. For example, if a sudden accident or road closure due to construction occurs, the AI can immediately propose an alternative route and notify the user.

The Mobility Integration Department integrates various transportation modes within the city. It manages public transportation (buses, trains), sharing services (bicycles, electric scooters), taxi services, and more on a single platform, providing users with a seamless mobility experience. For example, when a user sets a destination via a smartphone app, the system proposes the optimal combination of transportation modes and automatically makes the necessary reservations. This significantly reduces the hassle of transfers. Furthermore, the Mobility Integration Department updates real-time operational information for each mode of transport, providing users with the latest updates. For instance, it can instantly reflect train delay information or bus route status and notify users accordingly.

Finally, the Payment Department provides a function to consolidate fares for each mode of transportation and enable a single payment. Users can pay all travel expenses at once using credit cards or digital wallets. This eliminates payment complexity and reduces financial burden. Users can also manage their travel history and expenses within the app, viewing detailed reports on past trips. Furthermore, the Payment Department protects data using encryption technology to ensure secure and swift transactions. For instance, it encrypts user personal and payment information to safeguard against unauthorized access.

Thus, the present invention enables the sensor unit, AI analysis unit, mobility integration unit, and payment unit to collaborate, optimizing traffic management across the entire city and providing users with an efficient and comfortable mobility experience. This alleviates traffic congestion and improves citizens' mobility efficiency. It also contributes to reducing environmental impact and enhancing urban sustainability. Specifically, smoother traffic flow reduces vehicle idling time, leading to expected reductions in carbon dioxide emissions. Furthermore, by promoting the use of public transportation and sharing services, overall urban traffic volume decreases, contributing to the realization of a sustainable urban environment.

### System Configuration

The system according to this embodiment comprises a sensor unit, an AI analysis unit, a mobility integration unit, and a payment unit. The sensor unit collects real-time traffic data using sensors, surveillance cameras, and drones installed at major intersections and key traffic points within the city. Specifically, surveillance cameras monitor the flow of vehicles on roads and can measure traffic volume and speed. This enables accurate assessment of how congested specific roads are. Drones monitor traffic conditions over a wide area from the air, instantly detecting fluctuations caused by sudden accidents or events. For example, drones can monitor areas hosting specific events from above, providing real-time insights into participant flows and vehicle congestion. Furthermore, sensors may be installed at stations and bus stops to monitor public transportation operations and pedestrian flow. This enables the immediate acquisition and provision of delay information for buses and trains to users.

The AI analysis unit predicts traffic flow and generates optimal travel routes based on data collected by the sensor unit. Using machine learning algorithms, it compares historical traffic data with current conditions to forecast traffic patterns. For instance, it learns road congestion patterns during specific times and generates optimal routes based on this learning. Furthermore, the AI considers each citizen's travel history and preferences to provide personalized travel plans. This enables users to reach their destinations in the shortest possible time. Additionally, the AI monitors traffic conditions in real time and can respond to sudden traffic changes. For example, if a sudden accident or road closure due to construction occurs, the AI can immediately propose an alternative route and notify the user. Specific examples of prompts fed to the generative AI include: "Generate the optimal route based on traffic data" and "Monitor traffic conditions in real time and respond to fluctuations."

The Mobility Integration Unit integrates various transportation modes within the city. It manages public transportation (buses, trains), sharing services (bicycles, electric scooters), taxi services, etc., on a single platform, providing users with a seamless mobility experience. For example, when a user sets a destination via a smartphone app, the system proposes the optimal combination of transportation modes and automatically makes the necessary reservations. This significantly reduces the hassle of transfers. Furthermore, the Mobility Integration Department updates real-time operational information for each mode of transportation, providing users with the latest updates. For instance, it can instantly reflect train delay information or bus operational status and notify users. Specific examples of prompts to feed into the generative AI include: "Integrate transportation modes and propose the optimal travel plan" or "Update operational information in real time and provide it to users."

The Payment Department provides a function to consolidate fares for each mode of transportation and enable a single payment. Users can pay all travel expenses at once using credit cards or digital wallets. This eliminates payment hassles and reduces financial burden. Users can also manage their travel history and expenses within the app, viewing detailed reports on past trips. Furthermore, the payment section employs encryption technology to protect data, ensuring secure and swift transactions. For instance, it encrypts user personal information and payment details to safeguard against unauthorized access. Specific examples of prompt text to feed into the generative AI include: "Integrate fares and enable consolidated payments" and "Manage user expenditures and guarantee secure transactions."

Thus, the system according to this embodiment enables the optimization of citywide traffic management through the coordination of its various components, providing users with an efficient and comfortable mobility experience. This alleviates traffic congestion and improves citizens' mobility efficiency. It also contributes to reducing environmental impact and enhancing urban sustainability. Specifically, smoother traffic flow reduces vehicle idling time, leading to expected reductions in carbon dioxide emissions. Furthermore, by promoting the use of public transportation and sharing services, overall urban traffic volume decreases, contributing to the realization of a sustainable urban environment.

### Implementation Steps

### Step 1: Data Collection Step

The sensor unit collects traffic data in real time using sensors and surveillance cameras installed at major intersections and key traffic points throughout the city. Surveillance cameras monitor the flow of vehicles on roads and can measure traffic volume and speed. Drones monitor traffic conditions over a wide area from the air, immediately detecting fluctuations in traffic caused by sudden accidents or events. Additionally, sensors may be installed at stations and bus stops to track public transportation operations and pedestrian flow. This enables a comprehensive understanding of the city's overall traffic situation.

### Step 2: AI Analysis Step

The AI analysis unit predicts traffic flow and generates optimal traffic routes based on data collected from the sensor unit. It uses machine learning algorithms to compare historical traffic data with current conditions and predict traffic flow. It learns road congestion patterns during specific time periods and generates optimal traffic routes based on this learning. It also considers each citizen's travel history and preferences to provide personalized travel plans. Examples of prompt sentences fed to the generative AI include: "Generate the optimal route based on traffic data" and "Monitor traffic conditions in real time and respond to fluctuations."

### Step 3: Mobility Integration Step

The Mobility Integration Unit integrates various transportation modes within the city. It manages public transportation (buses, trains), sharing services (bicycles, electric scooters), taxi services, etc., on a single platform, providing users with a seamless travel experience. When a user sets a destination via a smartphone app, the system proposes the optimal combination of transportation modes and automatically makes necessary reservations. Specific examples of prompt sentences to feed into the generative AI include: "Integrate transportation modes and propose the optimal travel plan" or "Update operational information in real time and provide it to users."

### Step 4: Payment Processing Step

The payment module integrates fares from each transportation mode and provides a consolidated payment function. Users can pay all travel expenses at once using credit cards or digital wallets. This eliminates payment complexity and reduces financial burden. Users can also manage their travel history and expenses within the app, viewing detailed reports on past trips. Examples of prompt text to feed into the generative AI include: "Integrate fares and enable consolidated payment" or "Manage user expenditures and ensure secure transactions."

### Specific Use Cases

For example, consider a business professional working in an urban area who needs to efficiently reach their office during the morning rush hour. This user uses a dedicated smartphone application to set their departure location as home, their destination as the office, and their desired arrival time as 9:00 AM. Furthermore, the user inputs a preference to avoid congestion.

The sensor unit collects real-time traffic data using surveillance cameras and sensors installed around the user's home and at major intersections along the commute route. This enables monitoring of current traffic volume and public transportation operation status. Drones monitor major traffic routes from the air, instantly detecting traffic fluctuations caused by sudden accidents or events.

The AI analysis unit compares past traffic patterns with the current situation based on the collected data to generate the optimal commuting route. The AI considers the user's past travel history and preferences to provide a customized travel plan. In this case, the AI could suggest a route involving walking to the nearest station, taking a less crowded train, and then using a shared bicycle from a station near the office. Specific examples of prompts to feed into the generative AI include: "Generate the optimal commuting route based on the user's travel needs" or "Propose a travel plan that avoids congestion by considering real-time traffic data."

The Mobility Integration Department automatically books necessary transportation based on the proposed route. Users can book train tickets and shared bicycles all at once through the application. This significantly reduces the hassle of transfers and enables smooth travel. Specific examples of prompts fed to the generative AI include: "Integrate transportation options and provide users with the optimal travel plan" and "Update operational information in real time and notify users."

The payment section provides a function to consolidate fares for each transportation method and enable a single payment. Users can pay all travel expenses at once using credit cards or digital wallets. This eliminates payment complexity and reduces financial burden. Users can also manage their travel history and expenses within the app, viewing detailed reports on past trips. Specific examples of prompts to feed into the generative AI include: "Integrate fares and enable consolidated payments" and "Manage user expenditures and ensure secure transactions."

Thus, the present invention enables efficient and comfortable commuting in urban areas, reducing the stress associated with travel. This allows users to utilize their time effectively and improve their daily quality of life.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), and recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the acquisition unit is implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

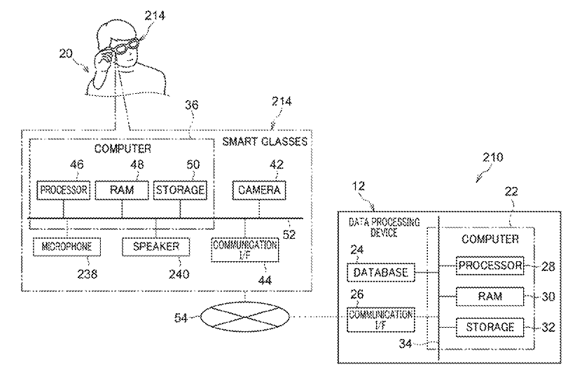

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions and the like. Microphone 238 captures the voice input from user 20, converts the captured voice into audio data, and outputs it to processor 46. Speaker 240 outputs audio according to instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

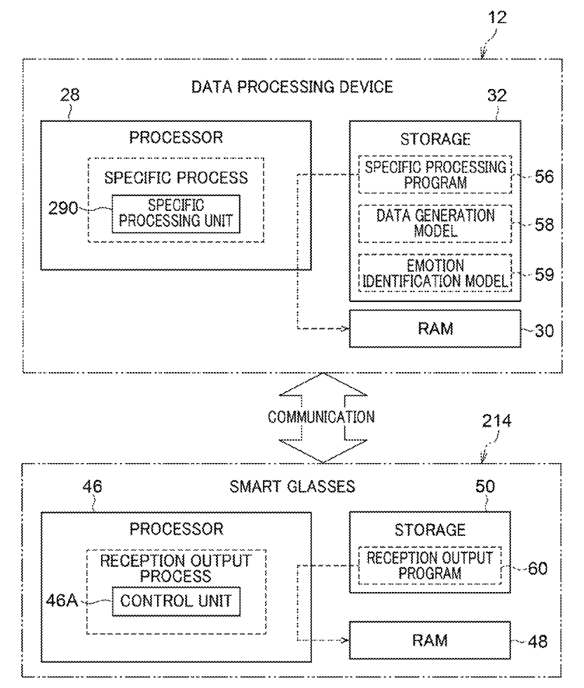

FIG. 4 shows an example of key functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" related to the technology of this disclosure. Processor 28 reads the specific processing program 56 from storage 32 and executes the read specific processing program 56 on RAM 30. The specific processing is realized by processor 28 operating as specific processing unit 290 according to the specific processing program 56 executed on RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is performed by the processor 46 acting as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, the specific processing performed by the specific processing unit 290 of the data processing device 12 will be described. The various parts of the system described below are implemented by the data processing device 12 and the smart glasses 214. In the following description, the data processing device 12 is referred to as the "server," and the smart glasses 214 are referred to as the "terminal."

### Example 1

The flow of the specific processing is the same as that described in Example 1 of the first embodiment, so the explanation is omitted.

### Application Example 1

The flow of the specific processing in Example 1 described in the above first embodiment is the same, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing by the data processing system 10 described above may be executed by the specific processing unit 290 of the data processing device 12 or by the control unit 46A of the smart device 14. Alternatively, the processing may be executed by the specific processing unit 290 of the data processing device 12 and the control unit 46A of the smart device 14. Furthermore, the data processing device 12's specific processing unit 290 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a configuration where specific processing is performed by the data processing device 12. However, the technology disclosed herein is not limited to this configuration; specific processing may also be performed by the smart glasses 214.

### Third Embodiment

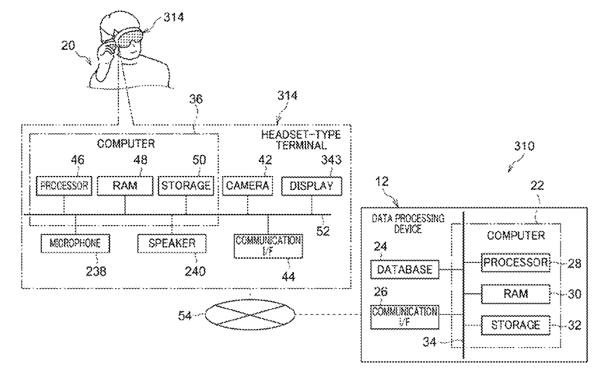

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The headset-type terminal 314 includes a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions and the like. Microphone 238 captures the voice input from user 20, converts the captured voice into audio data, and outputs it to processor 46. Speaker 240 outputs audio according to instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

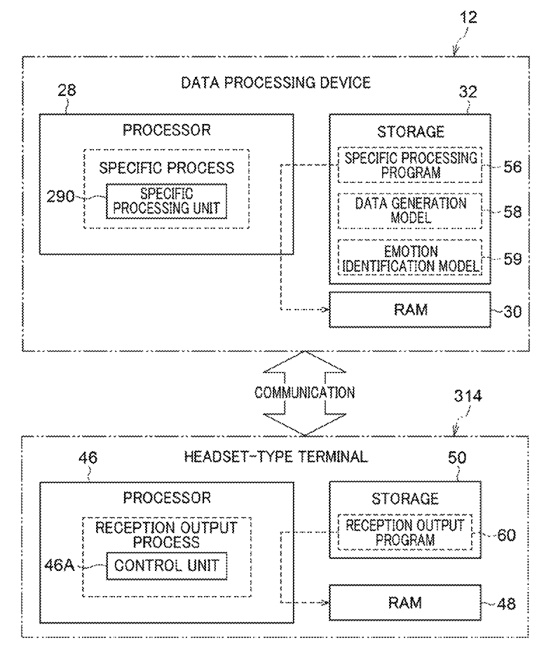

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A acquires the audio via the microphone 238. The voice data representing the acquired user input is transmitted to the data processing device 12. At the data processing device 12, the specific processing unit 290 acquires the voice data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the headset-type terminal 314.

### Fourth Embodiment

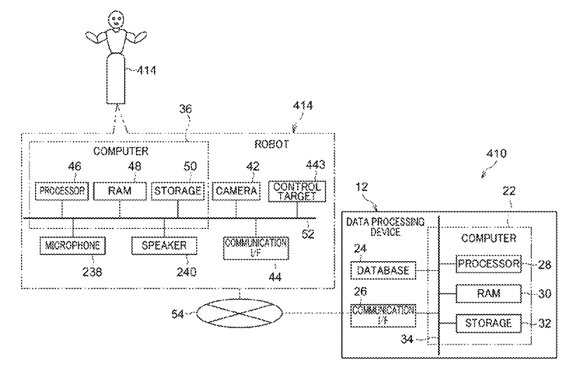

FIG. 7 shows an example configuration of the data processing system 410 according to the fourth embodiment.

As shown in FIG. 7, the data processing system 410 includes a data processing device 12 and a robot 414. An example of the data processing device 12 is a server.

Data processing device 12 includes a computer 22, a database 24, and a communication I/F 26. Computer 22 is an example of a "computer" related to the technology of this disclosure. Computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

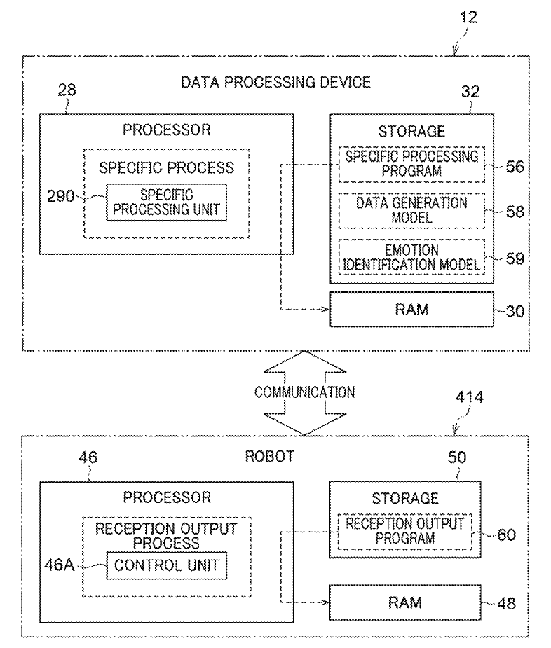

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" pertaining to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are realized by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input prompts containing instructions, as well as inference data such as audio data representing sound, text data representing text, and image data (e.g., still image data or video data) representing images. Data generation model 58 infers based on the input inference data according to the instructions indicated by the prompt and outputs the inference result in one or more of the data formats such as audio data, text data, and image data. The data generation model 58 may include, for example, text generation AI, image generation AI, multimodal generation AI, etc. Here, inference refers to, for example, analysis, classification, prediction, and/or summarization. The specific processing unit 290 performs the specific processing described above using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned parts is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

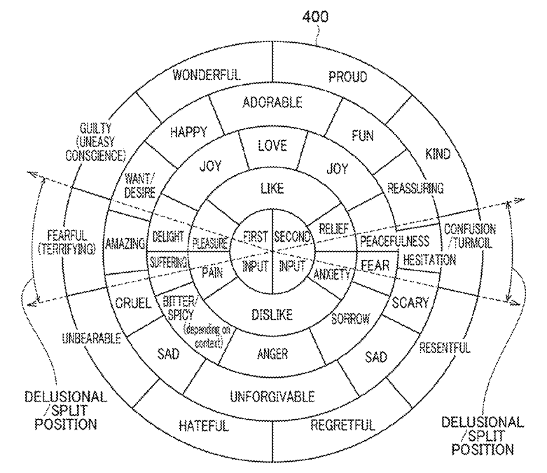

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged radially in concentric circles from the center. Emotions closer to the center of the concentric circles represent more primitive states. Emotions representing states or behaviors arising from mental states are placed further out in the concentric circles. Emotion is a concept that also includes affect and mental states. On the left side of the concentric circles are emotions generated from reactions generally occurring within the brain. Emotions encompass concepts including affect and mental states. On the left side of the concentric circles are emotions generally generated from reactions occurring within the brain. On the right side are emotions generally induced by situational judgment. Above and below the concentric circles are emotions generally generated from reactions occurring within the brain and also induced by situational judgment. Furthermore, the upper part of the concentric circle contains "pleasant" emotions, while the lower part contains "unpleasant" emotions. Thus, in the Emotion Map 400, multiple emotions are mapped based on the structure of their origin, and emotions that tend to occur simultaneously are mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents behavior. Therefore, the further out on the emotion map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. Emotion maps, for example, Dr. Mitsuyoshi's Emotion Map (Research on Speech Emotion Recognition and Neurophysiological Signal Analysis of Emotions, Tokushima University, Doctoral Dissertation: https://ci.nii.ac.jp/naid/500000375379). The left half of the emotion map displays emotions belonging to the "Reaction" area, where sensory input dominates. The right half of the emotion map displays emotions belonging to the "Situation" domain, where situational awareness is dominant.

The emotion map defines two emotions that promote learning. One is the negative emotion around the center of the "repentance" or "reflection" area on the situation side. That is, when the robot experiences negative emotions like "I never want to feel this way again" or "I don't want to be scolded anymore." The other is the positive emotion around "desire" on the reaction side. That is, when the robot feels positive emotions like "I want more" or "I want to know more."

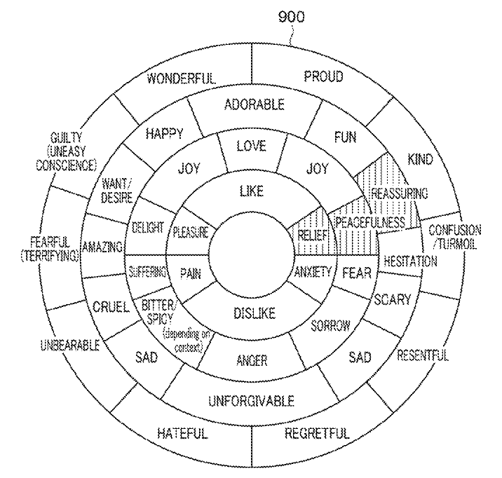

The emotion identification model 59 inputs user input into a pre-trained neural network, obtains emotion values representing each emotion shown in the emotion map 400, and determines the user's emotion. This neural network is pre-trained based on multiple training data sets, which are combinations of user input and emotion values representing each emotion shown in the emotion map 400. Furthermore, this neural network is trained such that emotions positioned close to each other, as shown in the emotion map 900 in FIG. 10, have similar values. FIG. 10 illustrates an example where multiple emotions, such as "reassurance," "tranquility," and "encouragement," have similar emotion values.

The above description primarily explains the system of the present disclosure in terms of the functions of the data processing device 12. However, the system of the present disclosure is not necessarily implemented on a server. The system of the present disclosure may be implemented as a general information processing system. For example, the present disclosure may be implemented as a software program operating on a personal computer or as an application operating on a smartphone or similar device. The method of the present disclosure may be provided to users in a SaaS (Software as a Service) format.

The above embodiment illustrated an example configuration where specific processing is performed by a single computer 22. However, the technology of this disclosure is not limited thereto. Distributed processing may be performed by multiple computers, including computer 22, for specific processing. For example, data generation model 58 may be provided on an external device of data processing device 12, and said external device may generate data corresponding to input data. For example, the data generation model 58 may be provided in an external device of the data processing device 12, and data generation corresponding to input data may be performed in said external device.

The above embodiment described a configuration where a specific processing program 56 is stored in storage 32, but the technology disclosed herein is not limited to this. For example, the specific processing program 56 may be stored on a portable, computer-readable non-volatile storage medium such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 on a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., a program. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing tasks. Each processor incorporates or connects to memory, and each processor executes specific processing by utilizing this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by combining one or more CPUs with software, with this processor functioning as the hardware resource executing specific processing. Second, there is a form using a processor that implements the entire system functionality, including multiple hardware resources executing specific processing, on a single IC chip, as exemplified by a System-on-a-chip (SoC). Thus, specific processing is implemented using one or more of the above various processors as hardware resources.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the above descriptions of the configuration, functions, actions, and effects are merely examples of the configuration, functions, actions, and effects pertaining to the technology disclosed herein. Therefore, it goes without saying that within the scope that does not deviate from the spirit of the technology disclosed herein, unnecessary portions may be omitted, new elements may be added, or replacements may be made to the above-described content and illustrated content. Furthermore, to avoid complexity and facilitate understanding of the technical aspects of the present disclosure, descriptions of common technical knowledge and the like that are not particularly necessary for enabling the present disclosure to have been omitted from the above descriptions and illustrations.

All references, patent applications, and technical specifications cited herein are incorporated by reference to the same extent as if each reference, patent application, and technical specification were specifically and individually cited herein.

The following further discloses the above embodiments.

### Supplementary Note 1

A system comprising a sensor unit, an AI analysis unit, and a mobility integration unit. The sensor unit collects real-time traffic data using sensors, surveillance cameras, and drones installed at major intersections and key traffic points within the city. The AI analysis unit uses machine learning algorithms to compare past traffic data with the current situation and predict traffic flow. The mobility integration unit integrates multiple transportation modes, such as public transportation, sharing services, bicycles, and walking, to provide users with a seamless mobility experience.

The system described in Supplementary Note 1, wherein the sensor unit monitors wide-area traffic conditions from the air using drones and instantly detects traffic fluctuations caused by sudden accidents or events. The AI analysis unit can generate optimal traffic routes based on this data and provide individualized travel plans to each citizen. This enables users to reach their destinations in the shortest possible time.

The system described in Supplementary Note 1, wherein the mobility integration unit proposes the optimal combination of transportation modes to users via a smartphone app and automatically makes necessary reservations. The payment unit provides a function to consolidate the fares for each transportation mode and settle them in a single transaction, allowing users to pay all travel expenses at once via credit card or digital wallet. This eliminates payment complexity and reduces the financial burden.

### EXPLANATION OF SYMBOLS

10, 210, 310, 410 Data Processing System

12 Data Processing Device

14 Smart Device

214 Smart Glasses

314 Headset-type devices

414 Robot

What is claimed is:

1. A distributed mobility management system, comprising:
a terminal device including an input interface configured to receive a travel request comprising at least an origin location and a destination location, and a display; and
a server system communicatively coupled to the terminal device via a network, the server system including one or more processors and one or more memories storing:
a historical traffic database storing historical travel data indexed by time and location,
a real-time data interface configured to receive road-traffic observation data from a plurality of sources including at least one fixed sensor and at least one camera or drone,
an image analysis model,
a traffic prediction model, and
a route computation engine;
wherein the one or more processors are configured to:
receive the travel request from the terminal device;
receive real-time road-traffic observation data via the real-time data interface;
generate, using the image analysis model, a congestion metric for each of a plurality of road segments by detecting vehicles in image data from the at least one camera or drone and computing at least one of vehicle density or average vehicle speed for each road segment;
generate, using the traffic prediction model and based on the historical traffic database and the congestion metric, predicted travel time values for the plurality of road segments for a defined prediction horizon;
compute, using the route computation engine, at least one candidate route between the origin location and the destination location by solving a constrained shortest-path problem whose edge weights include the predicted travel time values and that is subject to transportation-mode availability constraints; and
transmit route data corresponding to the at least one candidate route to the terminal device for presentation via the display.

2. The system of claim 1, wherein computing the congestion metric includes selecting a region-of-interest for each road segment and computing vehicle density as a vehicle count normalized by region-of-interest roadway length or area.

3. The system of claim 1, wherein the image analysis model further estimates a crowding metric for a public-transport vehicle or platform by detecting persons in image data, and wherein the constrained shortest-path problem enforces a crowding threshold that excludes public-transport edges whose crowding metric exceeds the threshold.

4. The system of claim 1, wherein the server system recomputes the at least one candidate route responsive to detecting that the congestion metric changes by more than a predefined threshold for a road segment on the candidate route.

5. The system of claim 1, further comprising a reservation module configured to transmit a reservation request to reserve an on-demand mobility service included as a leg of the at least one candidate route when an estimated arrival time at a pickup location is within a predefined time window.

6. The system of claim 1, further comprising a payment module configured to generate encrypted payment transaction data aggregating fare amounts for a plurality of transportation legs of the at least one candidate route.

7. A computer-implemented mobility management method performed by a server system communicatively coupled to a terminal device, comprising:
receiving, from the terminal device, a travel request comprising at least an origin location and a destination location;
receiving real-time road-traffic observation data from a plurality of sources including at least one fixed sensor and at least one camera or drone;
generating a congestion metric for each of a plurality of road segments by applying an image analysis model to image data to detect vehicles and compute at least one of vehicle density or average vehicle speed;
generating predicted travel time values for the plurality of road segments for a defined prediction horizon by applying a traffic prediction model to historical travel data and the congestion metric;
computing at least one candidate route between the origin location and the destination location by solving a constrained shortest-path problem whose edge weights include the predicted travel time values and that is subject to transportation-mode availability constraints; and
transmitting route data for presentation on the terminal device.

8. The method of claim 7, wherein computing vehicle density comprises counting detected vehicles within a region-of-interest associated with a road segment and normalizing the count by region-of-interest roadway length or area.

9. The method of claim 7, further comprising estimating a crowding metric by detecting persons in image data captured at a public-transport environment, and excluding route segments whose crowding metric exceeds a threshold.

10. The method of claim 7, further comprising recomputing the at least one candidate route responsive to detecting that the congestion metric for a road segment on the candidate route changes by more than a predefined threshold.

11. The method of claim 7, further comprising transmitting a reservation request for an on-demand mobility leg included in the at least one candidate route when an estimated arrival time at a pickup location is within a predefined time window.

12. The method of claim 7, further comprising generating encrypted payment transaction data aggregating fare amounts for a plurality of transportation legs of the at least one candidate route.

13. A non-transitory computer-readable medium storing instructions that, when executed by one or more processors of a server system, cause the server system to:
receive, from a terminal device, a travel request comprising at least an origin location and a destination location;
receive real-time road-traffic observation data from a plurality of sources including at least one fixed sensor and at least one camera or drone;
generate a congestion metric for each of a plurality of road segments by applying an image analysis model to detect vehicles in image data and compute at least one of vehicle density or average vehicle speed;
generate predicted travel time values for the plurality of road segments for a defined prediction horizon by applying a traffic prediction model to historical travel data and the congestion metric;
compute at least one candidate route by solving a constrained shortest-path problem whose edge weights include the predicted travel time values and that is subject to transportation-mode availability constraints; and
transmit route data to the terminal device.

14. The non-transitory computer-readable medium of claim 13, wherein the instructions cause the server system to compute vehicle density as a vehicle count normalized by region-of-interest roadway length or area.

15. The non-transitory computer-readable medium of claim 13, wherein the instructions cause the server system to estimate a crowding metric by detecting persons in image data and to exclude public-transport route edges that exceed a crowding threshold.

16. The non-transitory computer-readable medium of claim 13, wherein the instructions cause the server system to recompute the at least one candidate route responsive to detecting that the congestion metric changes by more than a predefined threshold for a road segment on the candidate route.

17. The non-transitory computer-readable medium of claim 13, wherein the instructions cause the server system to transmit a reservation request for an on-demand mobility service leg when an estimated arrival time at a pickup location is within a predefined time window.

18. The non-transitory computer-readable medium of claim 13, wherein the instructions cause the server system to generate encrypted payment transaction data aggregating fare amounts for a plurality of transportation legs of the at least one candidate route.
